(19) United States
(12) Patent Application Publication
(10) Pub. No.: US 2006/0266971 A1
(43) Pub. Date: Nov. 30, 2006

(54) Value for portable hermetic containers

(75) Inventor: Massimo Tonelli, Casalecchio Di Reno (IT)

Correspondence Address: MODIANO & ASSOCIATI, Via Meravigli, 16, MILAN, 20123, IT

(73) Assignee: G.T. LINE - S.R.L.

(21) Appl. No.: 11/434,776

(22) Filed: May 17, 2006

(30) Foreign Application Priority Data
May 27, 2005 (IT) B02005A000372

(51) Int. Cl. F16K 31/44

(52) U.S. Cl. 251/216; 251/351

(57) ABSTRACT

A valve for a portable hermetic container provided with at least one externally threaded stem engaged detachably in a respective through female thread, which passes through one of the outside walls of the container, and at least one manual actuation element rigidly coupled to the stem and provided with at least one sealing element for forming a seal on the external surface of the container. The valve is movable from one open configuration, to allow passage of air and/or other fluids through the female thread, to a closed configuration, in which the sealing element prevents passage of air and/or other fluids through the female thread and comprises a stroke limiter provided at the end of the stem and adapted to prevent the disengagement of the stem from the female thread.

The present invention relates to a valve for portable hermetic containers and the like.

### BACKGROUND OF THE INVENTION

Various kinds of portable container, such as cases, panniers and the like intended for particular applications, for example technical, professional and military applications, are currently commercially widespread in which the content of such containers must be protected carefully against the action of external agents and therefore also from sudden variations in atmospheric pressure (for example during transport on aircraft). For this purpose, modern portable containers of this type are provided with pressurization valves, which allow to maintain the pressure inside the container at the optimum preset value.

Some of these pressurization valves are of the manual type, i.e., they are constituted by a sort of screw, associated with a sealing gasket, which is adapted to obstruct, by being screwed in, a vent hole connected to the inside of the container; however, the valve, in the venting position, often inadvertently disengages from the female thread into which it is screwed, with the risk of subsequently losing it.

As an alternative to manual valves, pressurization valves of the fully automatic type have been devised which are produced in the most disparate shapes but are all characterized by some drawbacks, the main of which is that over time such valves tend to collect dirt and impurities, which inevitably compromise their operating effectiveness.

### SUMMARY OF THE INVENTION

The aim of the present invention is to obviate the above-mentioned drawbacks, by providing a valve for portable hermetic containers and the like which, while retaining the functional advantages which are typical of manual valves, offers the greatest assurances to the user against the risk of accidental loss.

Within this aim, an object of the present invention is to provide a valve for portable hermetic containers and the like which is flexible and versatile in application and is safe and effective in operation.

Another object of the present invention is to provide a valve which is simple, relatively easy to provide in practice, safe in use, effective in operation, and has a relatively low cost.

This aim and these and other objects which will become better apparent hereinafter are achieved by the present valve for portable hermetic containers and the like, of the type provided with at least one externally threaded stem, which is engaged detachably in a respective through female thread, which passes through one of the outside walls of said container, and at least one manual actuation element, which is rigidly coupled to said stem and is provided with at least one element for forming a seal on the external surface of the container, said valve being movable from at least one open configuration, in which it allows the passage of air and/or other fluids through said female thread, to at least one closed configuration, in which said sealing element prevents the passage of air and/or other fluids through said female thread, thus keeping unchanged the pressure within the container, characterized in that it comprises stroke limiting means, which are provided substantially at the end of said stem and are adapted to prevent the disengagement of said stem from said female thread when the valve is in the closed position.

### BRIEF DESCRIPTION OF THE DRAWINGS

Further characteristics and advantages of the invention will become better apparent from the following detailed description of a preferred but not exclusive embodiment of a valve for portable hermetic containers and the like according to the invention, illustrated by way of non-limiting example in the accompanying drawings, wherein:

FIG. 1 is a front view of the valve according to the invention;

FIG. 2 is a side elevation view of said valve;

FIG. 3 is a view of the valve from the inside of the portable container;

FIG. 4 is a sectional view of the valve according to the invention, taken along the line IV-IV of FIG. 1;

FIG. 5 is a detail side elevation view of the stem of the valve;

FIG. 6 is a detail perspective view of the stem of the valve.

### DESCRIPTION OF THE PREFERRED EMBODIMENTS

In the exemplary embodiment that follows, individual characteristics may actually be interchanged with other different characteristics that exist in other exemplary embodiments.

Moreover, it is noted that anything found to be already known during the patenting process is understood not to be claimed and to be the subject of a disclaimer.

With reference to the figures, the reference numeral 1 generally designates a valve for portable hermetic containers and the like according to the invention.

The valve 1 can be installed equally and advantageously on any container of the portable type, such as cases, panniers and others, particularly but not exclusively for portable containers intended for technical and professional applications, in which it is necessary to maintain the internal environment of the container at a preset pressure, regardless of any variations of the external pressure (for example, transport by aircraft).

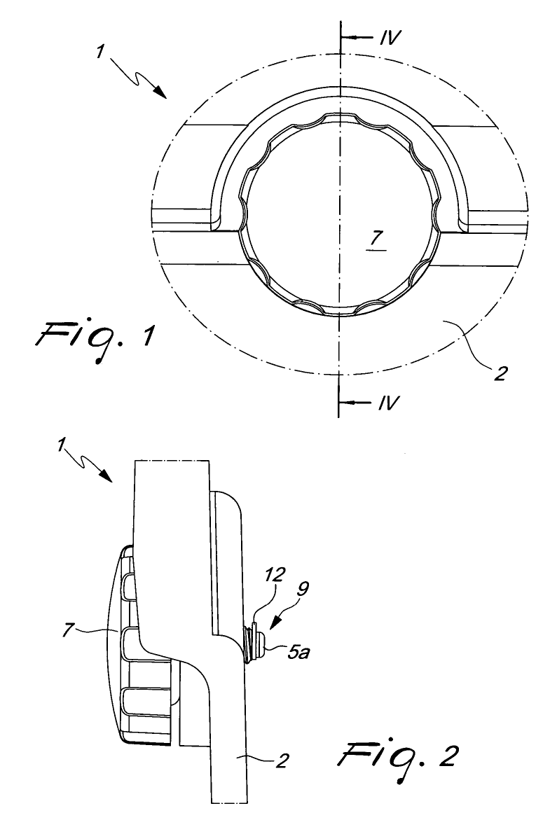

With reference to FIGS. 1 and 2, the valve according to the invention is fitted on one of the external walls 2 of a portable container, such as a case or pannier or other container, such walls forming an external surface 3 and being adapted to isolate an internal chamber 4, which contains objects and/or devices which must be kept at a preset pressure without being affected by external variations.

The valve 1 comprises at least one externally threaded stem 5, which has an end 5a and is engaged detachably in a respective through female thread 6, which passes through the external wall 2; the valve further comprises a manual actuation element 7, which is shaped substantially like a knob, is rigidly coupled to the stem 5 and is provided with at least one element 8 for forming a seal on the external surface 3 of the container.

The valve 1 can be moved manually, by turning the element 7 in one direction or the other, from at least one open configuration, in which it allows the passage of air and/or other fluids through the opening formed by the female thread 6, to at least one closed configuration, in which the sealing element 8 prevents the passage of air and/or other fluids through the female thread 6, thus keeping unchanged the pressure inside the chamber 4.

According to the invention, the valve 1 comprises advantageously stroke limiting means 9, which are provided at the end 5a of the stem 5 and are adapted to prevent the disengagement of the stem 5 from the female thread 6 with the valve in the closed configuration, shown in FIGS. 2 and 4: this refinement allows to avoid the risk of losing the valve when it is in the open position.

The stem 5 of the valve is extended, on the opposite side with respect to the end 5a, with a hexagonal head 10, which is recessed in a receptacle 11 provided in the manual actuation element 7.

The stroke limiting means 9 conveniently comprise at least one ring 12, which is engaged in a respective annular groove 13 provided at the end 5a of the stem 5 and the outside diameter of which is larger than the inside diameter of the female thread 6.

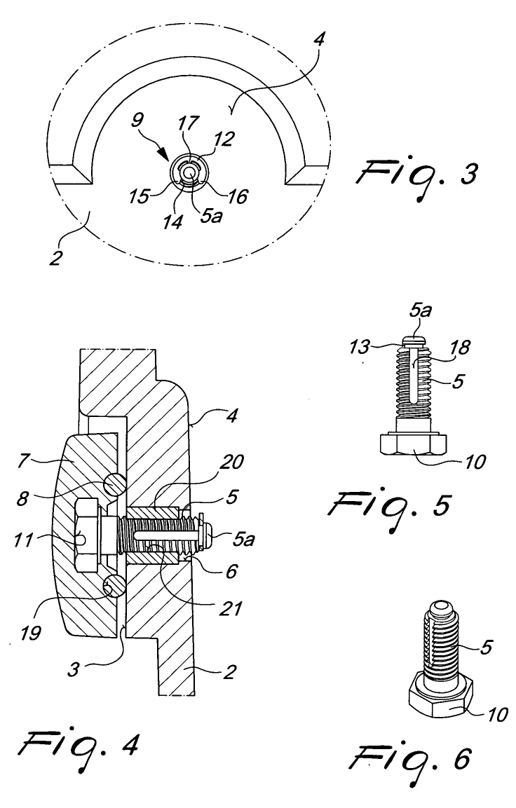

The ring 12 is conveniently of the elastic type, is provided with an opening 14 for snap insertion in the annular groove 13, and is provided with at least three portions having a larger cross-section which are adapted to engage the bottom of the groove 13, in particular two lateral portions 15, 16 and a central portion 17 (which are visible in FIG. 3).

The stem 5 of the valve is affected by at least one longitudinal slot 18 of an appropriately selected width, which starts preferably from the groove 13 and runs along the thread of the stem 5 over almost its entire length: the longitudinal slot 18 is advantageously suitable to increase the flow-rate of air and/or other fluid which flows through the female thread 6 when the valve is arranged in the open configuration. In other words, the slot 18 allows to simply achieve rapid venting of the chamber 4.

The element 8 for forming a seal on the external surface 3 of the container is constituted conveniently by at least one annular gasket made of elastomer (or of another material having similar characteristics), which is fitted in a respective annular receptacle 19 provided in the internal face of the manual actuation element 7.

The female thread 6, in which the stem 5 of the valve engages, is preferably formed within a sort of bush 20, which is locked for example by pressing within a respective through hole 21 formed in the external wall 2 of the portable container.

The method of use of the valve according to the invention is fully intuitive. With the stem 5 completely screwed into the female thread 6, the valve 1 is in the closed configuration (FIGS. 2 and 4), i.e., in the configuration in which the compression of the sealing element 8 on the external surface 3 of the container allows to keep the chamber 4 at the intended pressure.

In order to achieve venting, one acts on the manual actuation element 7, unscrewing the stem 5 from the female thread 6 and thus separating the sealing element 8 from the external surface 3. The air (or other fluid) flows mainly through the longitudinal slot 18: it is evident that in order to achieve rapid venting it is necessary to unscrew completely the stem 5 from the female thread 6, and in this fully open configuration of the valve the stroke limiting means 9 prevent the stem 5 from disengaging, without any risk of loss.

It has thus been shown that the invention achieves the proposed aim and objects.

The invention thus conceived is susceptible of numerous modifications and variations, all of which are within the scope of the appended claims.

All the details may further be replaced with other technically equivalent ones.

The embodiment of the present invention shall be carried out in the most scrupulous compliance with the statutory and regulatory provisions related to the products of the invention or correlated thereto and following any required authorization of the corresponding competent authorities, with particular reference to regulations related to safety, environmental pollution and health.

In practice, the materials used, as well as the shapes and the dimensions, may be any according to requirements without thereby abandoning the scope of the protection of the appended claims.

The disclosures in Italian Patent Application No. BO2005A000372 from which this application claims priority are incorporated herein by reference.

What is claimed is:

1. A valve for a portable hermetic container provided with outside walls, an external surface, the valve comprising: at least one externally threaded stem, which is engaged detachably in a respective through female thread, which passes through one of said outside walls of the container; at least one manual actuation element, which is rigidly coupled to said stem and is provided with at least one element for forming a seal on the external surface of the container, the valve being movable from at least one open configuration, in which the valve allows passage of air and/or other fluids through said female thread, to at least one closed configuration, in which said sealing element prevents the passage of air and/or other fluids through said female thread so as to keep unchanged a pressure within the container; stroke limiting means, provided at an end of said stem, said stroke limiting means being adapted to prevent disengagement of said stem from said female thread when the valve is in the closed configuration.

2. The valve of claim 1, wherein said stroke limiting means comprise at least one ring, which is engaged in a respective annular groove provided at the end of said stem, an outside diameter of said ring being larger than an inside diameter of said female thread.

3. The valve of claim 2, wherein said ring is elastic and provided with an opening for snap insertion in said groove and comprises at least three portions which have a larger cross-section and are adapted to engage a bottom part of said groove.

4. The valve of claim 2, comprising a bush in which said female thread is provided and which is locked in a respective through hole provided in one of the outside walls of the portable container.

5. The valve of claim 4, wherein said stem is provided with at least one longitudinal slot, which is adapted to increase a flow-rate of air and/or other fluid which passes through said female thread when the valve is arranged in the open configuration.

6. The valve of claim 4, wherein said manual actuation element comprises a receptacle, said stem having a hexagonal head, which is recessed in said receptacle.

7. The valve of claim 4, comprising a respective annular receptacle provided in an internal face of said manual actuation element, said sealing element being constituted by at least one annular gasket, which is fitted within said annular receptacle.
